(19) United States
(12) Patent Application Publication
(10) Pub. No.: US 2021/0133638 A1
(43) Pub. Date: May 6, 2021

(54) Workspace Managing Method and Workspace Managing System Capable of Improving a Scheduling Efficiency

(71) Applicant: IADEA CORPORATION, Taipei City (TW)

(72) Inventors: Chia-Chin Wang, Taipei City (TW); Yung-Chieh Lin, Taipei City (TW); Yung-Tsai Wang, Taoyuan City (TW)

(21) Appl. No.: 16/675,233

(22) Filed: Nov. 6, 2019

(51) Int. Cl. G06Q 10/02; G06Q 10/10

(52) U.S. Cl. CPC G06Q 10/02; G06Q 10/1093

(57) ABSTRACT

A workspace managing method includes checking a reservation state of a workspace during a time interval for generating a checking result signal, indicating the reservation state of the workspace by using a display device of the workspace according to the checking result signal, detecting a presence of a person in the workspace for generating a detection result signal, and controlling the display device of the workspace according to the detection result signal.

### BACKGROUND OF THE INVENTION

### 1. Field of the Invention

The present invention illustrates a workspace managing method and a workspace managing system, and more particularly, a workspace managing method and a workspace managing system capable of improving a scheduling efficiency and avoiding scheduling conflicts.

### 2. Description of the Prior Art

With rapid developments of technologies, various reservation systems and reservation methods for booking at least one workspace are adopted in our daily life. For example, when a user wants to use a workspace (i.e., such as a conference room, a meeting room or a work desk), the user can use an application program (app) of a smartphone for remotely booking an available workspace. After the user completes a process of booking the available workspace, the workspace booked by the user becomes a “reserved” workspace. The reserved workspace is unavailable for other users. Further, the reservation technology can be applied for booking seats in a cinema. For example, after a cinema booking app is installed in the smartphone of the user, the user can select and reserve at least one seat in the cinema through the smart phone before a movie starts.

In conventional reservation technologies, since the workspace lacks of introducing sensors for detecting a presence of the person, the reservation system cannot dynamically perform an occupancy analysis process in real time. Further, no physical or virtual indicator is introduced for displaying allocation information of scheduling all workspaces in real time. In other words, since no allocation information of scheduling all workspaces is provided by the reservation system in real time, when the reserved workspace is vacant, a scheduling efficiency of the workspaces is decreased.

### SUMMARY OF THE INVENTION

In an embodiment of the present invention, a workspace managing method is disclosed. The workspace managing method comprises checking a reservation state of a workspace during a time interval for generating a checking result signal, indicating the reservation state of the workspace by using a display device of the workspace according to the checking result signal, detecting a presence of a person in the workspace for generating a detection result signal, and controlling the display device of the workspace according to the detection result signal.

In another embodiment of the present invention, a workspace managing system is disclosed. The workspace managing system comprises a workspace and a server. The workspace has at least one sensor and a display device. The at least one sensor is configured to detect a presence of a person. The display device is configured to display an indication state. The server is linked to the at least one workspace and configured to control the display device and manage the workspace. The server checks a reservation state of the workspace during a time interval for generating a checking result signal. The display device displays the indication state of the workspace according to the checking result signal. The at least one sensor detects the presence of the person in the workspace for generating a detection result signal to the server. The server controls the display device of the workspace according to the detection result signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a workspace managing system according to an embodiment of the present invention.

FIG. 2 is a first part of a flow chart of a workspace managing method performed by the workspace managing system in FIG. 1.

FIG. 3 is a second part of the flow chart of the workspace managing method performed by the workspace managing system in FIG. 1.

### DETAILED DESCRIPTION

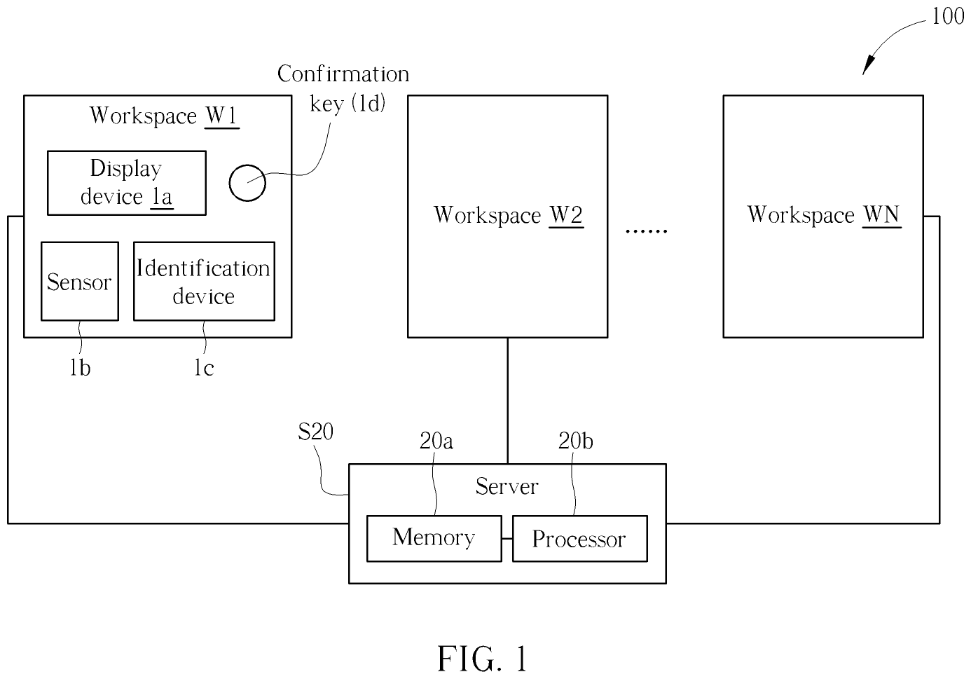

FIG. 1 is a block diagram of a workspace managing system 100 according to an embodiment of the present invention. The workspace managing system 100 can be applied to any bookable place, such as a library with a plurality of conference rooms, an office building with a plurality of meeting rooms or a studio place with a plurality of work desks. The workspace managing system 100 includes a plurality of workspaces W1 to WN and a server S20. N is a positive integer. The plurality of workspaces W1 to WN can be identical or different. Each workspace can be a conference room, a meeting room, a work desk, or any bookable space. For simplicity, a structure of the workspace W1 is illustrated hereafter. The workspace W1 has at least one sensor 1b and a display device 1a. The sensor 1b is used for detecting the presence of a person. The sensor 1b can be an infrared sensor, a thermal sensor, a laser sensor, and/or an ultrasonic sensor. The display device 1a is used for indicating a status of the workspace W1. The display device 1a can be a light emitting device, a screen, or any data transmission device. The display device 1a can use the color of light or display an image for indicating a current status of the workspace W1. The workspace W1 can also have an identification device 1c and a confirmation key 1d. The identification device 1c can be a card reader, a fingerprint reader, a touch panel, an iris recognizer, or any device capable of recognizing a person's identity. The identification device 1c and the confirmation key 1d can be integrated into the sensor or can be omitted in other embodiments. Any reasonable hardware modification falls into the scope of the present invention.

The server S20 is linked to all workspaces W1 to WN for controlling the display devices and managing the workspaces W1 to WN. The server S20 can be a backend scheduling system, a control center, or a cloud computer. The server S20 can include a memory 20a and a processor 20b coupled to the memory 20a. The memory 20a is used for saving identification data of all persons authorized for using the workspaces W1 to WN. The processor 20b can be used for communicating with the display device 1a, the at least one sensor 1b, the identification device 1c, and the confirmation key 1d of the workspace W1. The processor 20b can also be used for communicating with workspaces W2 to WN of the workspace managing system 100. In the workspace managing system 100, for the workspace W1, the server S20 can check a reservation state of the workspace W1 during a time interval for generating a checking result signal. The display device 1a can display the indication state of the workspace W1 according to the checking result signal. Then, the at least one sensor 1b can detect the presence of the person who has made a reservation within the workspace W1 for generating a detection result signal to the server S20. Then, the server S20 can control the display device 1a of the workspace W1 according to the detection result signal. The workspace managing system 100 can perform a similar process for managing the workspaces W2 to WN. Details of a workspace managing method performed by the workspace managing system 100 are illustrated below.

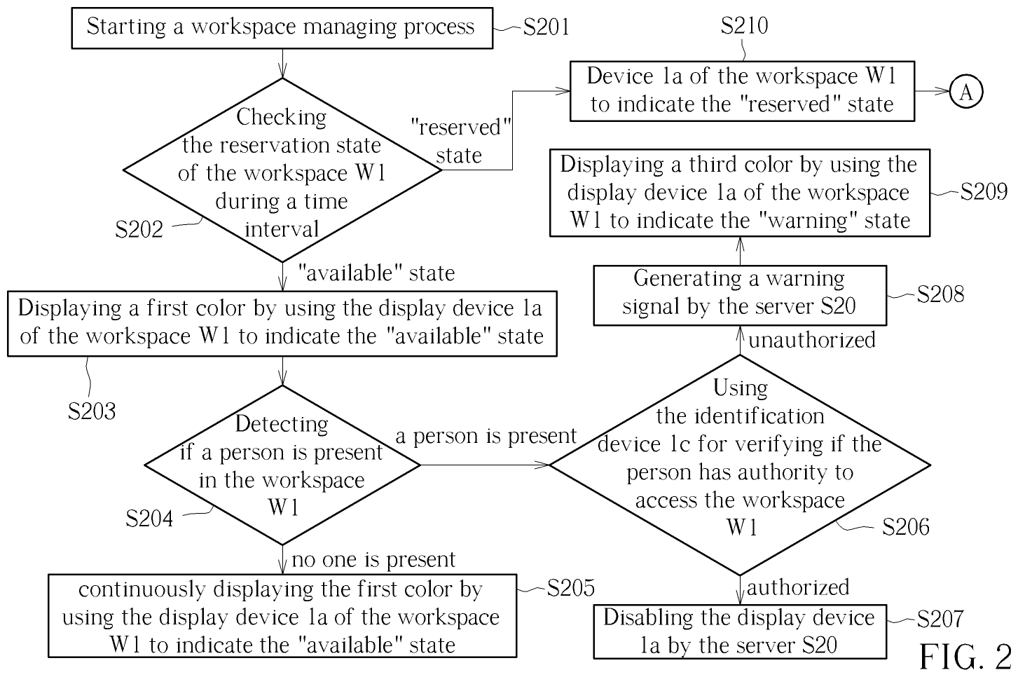

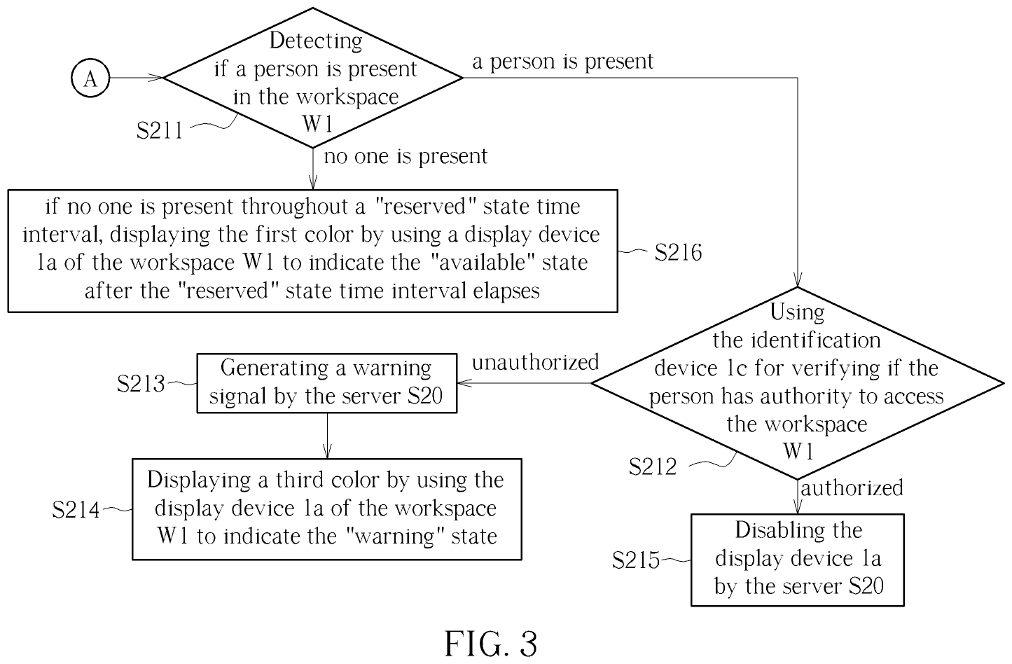

FIG. 2 is a first part of a flow chart of the workspace managing method performed by the workspace managing system 100. FIG. 3 is a second part of the flow chart of the workspace managing method performed by the workspace managing system 100. The workspace managing method can include step S201 to step S216. Any reasonable technology modification falls into the scope of the present invention. The step S201 to step S216 are illustrated below.
step S201: starting a workspace managing process;
step S202: checking the reservation state of the workspace W1 during a time interval; if the workspace W1 is in an “available” state, executing step S203; if the workspace W1 is in a “reserved” state, executing step S210;
step S203: displaying a first color by using the display device 1a of the workspace W1 to indicate the “available” state;
step S204: detecting if a person is present in the workspace W1; if no one is present, executing step S205; if a person is present, executing step S206;
step S205: continuously displaying the first color by using the display device 1a of the workspace W1 to indicate the “available” state.
step S206: using the identification device 1c for verifying if the person has authority to access the workspace W1; if so, executing step S207; if not, executing step S208;
step S207: disabling the display device 1a by the server S20.
step S208: generating a warning signal by the server S20;
step S209: displaying a third color by using the display device 1a of the workspace W1 to indicate the “warning” state.
step S210: displaying a second color by using the display device 1a of the workspace W1 to indicate the “reserved” state;
step S211: detecting if a person is present in the workspace W1; if a person is present, executing step S212; if no one is present, executing step S216;
step S212: using the identification device 1c for verifying if the person has authority to access the workspace W1; if not, executing step S213; if so, executing step S215;
step S213: generating a warning signal by the server S20;
step S214: displaying a third color by using the display device 1a of the workspace W1 to indicate the “warning” state.
step S215: disabling the display device 1a by the server S20.
step S216: if no one is present throughout a “reserved” state time interval, displaying the first color by using a display device 1a of the workspace W1 to indicate the “available” state after the “reserved” state time interval elapses.

In step S201, the workspace managing system 100 starts to perform the workspace managing process. The workspace managing process can be executed by using an application program or software installed in the memory 20a of the server S20. In step S202, the server S20 can check the reservation state of the workspace W1 during the time interval. For example, after the user uses the application program of the smartphone for booking the workspace W1, the reservation data can be saved in the memory 20a of the server S20. Therefore, the processor 20b of the server S20 can access the memory 20a for acquiring the reservation state of the workspace W1 during the time interval (i.e., for example, the workspace W1 is reserved during 2:00 PM to 5:00 PM). When the reservation state of the workspace W1 during the time interval is set as an “available” state, the processor 20b of the server S20 can generate the checking result signal for indicating that the workspace W1 is currently available. Then, in step S203, the display device 1a of the workspace W1 can display a first color according to the checking result signal to indicate the “available” state. The first color can be a “green” color or any user-defined color. Then, in step S204, the server S20 can use the at least one sensor 1b for detecting if a person is present in the workspace W1. When the reservation state of the workspace W1 is set as the “available” state, and no one is present, the processor 20b of the server S20 can generate a detection result signal for indicating that the workspace W1 is currently vacant. Then, in step S205, the processor 20b of the server S20 can control the display device 1a for continuously displaying the first color according to the detection result signal. When the reservation state of the workspace is set as the “available” state, and a person in the workspace is present during the “available” state time interval, the processor 20b of the server S20 can generate the detection result signal for indicating that the workspace is currently occupied. Then, in step S206, the server S20 can use the identification device 1c for verifying if the person has authority to access the workspace W1. In practice, the identification device 1c can generate the identification signal to the server S20. The server S20 can match the identification data of all authorized persons saved in the memory 20a with the identification signal for determining if the person in the workspace W1 is authorized. If the person in the workspace W1 is authorized, the processor 20b of the server S20 can disable the display device 1a according to step S207. Since the display device is disabled, no optical interference is introduced to the workspace W1. When the person is unauthorized, the processor 20b of the server S20 can generate the warning signal according to step S208. Then, the processor 20b of the server S20 can control the display device 1a of the workspace W1 to flick for indicating the warning state according to step S209.

When the reservation state of the workspace W1 during the time interval is set as a “reserved” state, the processor 20b of the server S20 can generate the checking result signal for indicating that the workspace is currently unavailable. Then, in step S210, the display device 1a of the workspace W1 can display a second color according to the checking result signal to indicate the “reserved” state. The second color can be a “red” color or any user-defined color different from the first color. Then, in step S211, the server S20 can use the at least one sensor 1b for detecting the presence of a person in the workspace W1. When the reservation state of the workspace W1 is set as the “reserved” state, and a person in the workspace W1 is present during the “reserved” state time interval, the processor 20b of the server S20 can generate the detection result signal for indicating that the workspace W1 is currently occupied. Then, in step S212, the server S20 can use the identification device 1c for verifying if the person has authority to access the workspace W1. Similarly, the identification device 1c can generate the identification signal to the server S20. The server S20 can match the identification data of all authorized persons saved in the memory 20a with the identification signal for determining if the person is authorized to access the workspace W1. If the person is unauthorized, the processor 20b of the server S20 can generate a warning signal according to step S213. Then, the processor 20b of the server S20 can control the display device 1a of the workspace W1 to flick for indicating the warning state according to step S214. If the person is authorized, the processor 20b of the server S20 can disable the display device 1a according to step S215. Since the display device is disabled, no optical interference is introduced in the workspace W1. In step S216, when the reservation state of the workspace is set as the “reserved” state, and no one is present throughout the “reserved” state time interval, the processor 20b of the server S20 can generate the detection result signal for indicating that the workspace is currently vacant after the “reserved” state time interval elapses. Then, the processor 20b of the server S20 can control the display device 1a of the workspace W1 for displaying the first color to indicate the “available” state.

Therefore, in the workspace managing system 100, several states of the workspaces W1 to WN can be displayed for the user in real time. For example, when some display devices currently display green light, it implies that these workspaces can be accessed currently. When some display devices currently display red light, it implies that these workspaces cannot be accessed currently. When no light signal is displayed by a display device, it implies that a corresponding workspace may be currently occupied by another authorized person. When a warning light signal is displayed by a display device, it implies that a corresponding workspace is currently used by an unauthorized person. By doing so, allocation information of scheduling all workspaces can be provided by the workspace managing system 100 in real time, thereby improving a scheduling efficiency.

As previously mentioned, step S201 to step S216 can be reasonably modified. For example, a period of time can be set by the user through the server S20. The period of time can also be a system default value. When the person is present in the workspace W1, and subsequently absent during the period of time, the server S20 can control the display device 1a to indicate the workspace W1 is currently occupied during the period of time. The server S20 can control the display device 1a to display the second color (red). In other words, the period of time can be regarded as a tolerance time for delaying to change the indication state by the server S20. Therefore, when a person in the workspace is present, and subsequently absent for a time period longer than the period of time, the server S20 can control the display device 1a for indicating that the workspace is currently vacant. The server S20 can control the display device 1a for displaying the first color (green) if the workspace W1 is non-reserved. Further, a notification state of the workspace W1 can be introduced to the workspace managing system 100. For example, a reservation time interval of the workspace W1 is set during 3:00 PM to 5:00 PM by the user. The server S20 can control the display device 1a for displaying the notification state when the reservation time interval of the workspace is to be expired (i.e., for example, 4:59 PM). The notification state displayed by using the display device 1a has a third color. The third color can be an “orange” color or any user-defined color different from the first color and the second color. By doing so, the user can be intuitively informed which workspaces are going to be available. Further, the confirmation key 1d can be introduced to the workspace managing system 100 for confirming the presence of the person. The confirmation key 1d can be a physical button or a virtual key. For example, after the person occupies the workspace W1, the person can press the confirmation key 1d for triggering the processor 20b to generate the detection result signal. In other words, the confirmation key 1d can be regarded as a check-in key of the workspace W1. Any reasonable hardware or technology modification falls into the scope of the present invention.

In the workspace managing system 100, as previously mentioned, the display device 1a can be controlled by the server S20. For example, the server S20 can control the display device 1a to display different colors for indicating different states of the workspace W1. However, the present invention is not limited to using different colors for indicating different states of the workspace W1. For example, instead of displaying “the first color” by using the display device 1a, the display device 1a can use “a first display configuration” for indicating a state of the workspace W1. Instead of displaying “the second color” by using the display device 1a, the display device 1a can use “a second display configuration” for indicating a state of the workspace W1. Instead of displaying “the third color” by using the display device 1a, the display device 1a can use “a third display configuration” for indicating a state of the workspace W1. Here, different display configurations can be different brightness values, different color tones, different flashing frequencies, or any reasonable different optical signals displayed by the display device 1a. Further, when the workspace W1 is currently occupied, instead of disabling the display device 1a, the server S20 can control the display device 1a to enter an operating state. The operating state can be previously configured by the server S20. For example, the display device 1a can be controlled to enter a dark state by dimming its brightness. The display device 1a can be controlled to enter a color adjustment state by changing its color. The display device 1a can be controlled to enter a sleeping state or a power-off state by disabling its power. Any reasonable technology modification falls into the scope of the present invention.

To sum up, the present invention discloses a workspace managing system and a workspace managing method. The workspace managing system can use at least one sensor and visual indicators for displaying allocation information of scheduling all workspaces in real time. The workspaces can be scheduled or reserved according to requirements of the users. Further, the workspace managing system can automatically detect the presence of a person in the workspace. After the presence of the person in the workspace is detected, a server (i.e., a backend scheduling system) can control a display device of the workspace for indicating the current status of the workspace. By doing so, since the allocation information of scheduling all workspaces and indication states of all workspaces can be provided by the workspace managing system, the user can remotely acquire availability information of all workspaces and make a reservation for an appropriate workspace without any conflicts. Thus, the workspace managing system and the workspace managing method can improve a scheduling efficiency of workspaces.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A workspace managing method comprising:
checking a reservation state of a workspace during a time interval for generating a checking result signal;
indicating the reservation state of the workspace by using a display device of the workspace according to the checking result signal;
detecting a presence of a person in the workspace for generating a detection result signal; and
controlling the display device of the workspace according to the detection result signal.

2. The method of claim 1, further comprising:
when the reservation state of the workspace during the time interval is set as a “available” state, generating the checking result signal indicating the workspace is currently available.

3. The method of claim 2, wherein the indication state displayed by using the display device has a first display configuration.

4. The method of claim 1, further comprising:
when the reservation state of the workspace during the time interval is set as a “reserved” state, generating the checking result signal indicating the workspace is currently unavailable.

5. The method of claim 4, wherein the indication state displayed by using the display device has a second display configuration.

6. The method of claim 1, further comprising:
if the reservation state of the workspace is set as a “available” state, when a person is present in the workspace during a “available” state time interval, generating the detection result signal indicating the workspace is currently occupied.

7. The method of claim 6, wherein controlling the display device of the workspace according to the detection result signal is controlling the display device to enter an operating state according to the detection result signal.

8. The method of claim 1, further comprising:
if the reservation state of the workspace is set as a “available” state, when no one is present in the workspace, generating the detection result signal indicating the workspace is currently vacant.

9. The method of claim 8, wherein controlling the display device of the workspace according to the detection result signal is controlling the display device to display a first display configuration according to the detection result signal.

10. The method of claim 1, further comprising:
if the reservation state of the workspace is set as a “reserved” state, when no one is present in the workspace throughout a “reserved” state time interval, generating the detection result signal indicating the workspace is currently vacant after the “reserved” state time interval elapses.

11. The method of claim 10, wherein the indication state displayed by using the display device has a first display configuration.

12. The method of claim 1, further comprising:
if the reservation state of the workspace is set as a “reserved” state, when a person is present in the workspace during a “reserved” state time interval, generating the detection result signal indicating the workspace is currently occupied.

13. The method of claim 12, wherein controlling the display device of the workspace according to the detection result signal is controlling the display device to enter an operating state according to the detection result signal.

14. The method of claim 1, further comprising:
using an identification device for verifying if the person has authority to access the workspace;
generating an identification signal to a server; and
when the person is unauthorized, generating a warning signal by the server.

15. The method of claim 1, further comprising:
setting a period of time; and
when the person is present in the workspace, and subsequently absent during the period of time, controlling the display device to indicate the workspace is currently occupied during the period of time.

16. The method of claim 15, wherein the indication state displayed by using the display device has a second display configuration.

17. The method of claim 1, further comprising:
setting a period of time; and
when the person is present in the workspace, and subsequently absent for a time period longer than the period of time, controlling the display device to indicate the workspace is currently vacant.

18. The method of claim 1, further comprising:
displaying a third display configuration by using the display device when a reservation time interval of the workspace is to be expired to indicate the notification state.

19. The method of claim 1, wherein detecting the presence of the person in the workspace for generating the detection result signal is triggering a confirmation key of the workspace by the person for generating the detection result signal.

20. A workspace managing system comprising:
a workspace having:
at least one sensor configured to detect a presence of a person; and
a display device configured to display an indication state; and
a server linked to the at least one workspace and configured to control the display device and manage the workspace;
wherein the server checks a reservation state of a workspace during a time interval for generating a checking result signal, the display device indicates the reservation state of the workspace according to the checking result signal, the at least one sensor detects a presence of a person in the workspace for generating a detection result signal, and the server controls the display device of the workspace according to the detection result signal.
